(19) United States
(12) Patent Application Publication
(10) Pub. No.: US 2011/0293984 A1
(43) Pub. Date: Dec. 1, 2011

(54) Enhanced high voltage terminal cooling with a high thermal conductivity coating

(75) Inventors: Taeyoung Han, Bloomfield Hills, MI (US); Kuo-Huey Chen, Troy, MI (US); Bahram Khalighi, Troy, MI (US); Jan H. Aase, Oakland Township, MI (US)

(73) Assignee: GM GLOBAL TECHNOLOGY OPERATIONS, INC., Detroit, MI (US)

(21) Appl. No.: 12/802,031

(22) Filed: May 28, 2010

(51) Int. Cl. H01M 10/50; B05D 5/00; B05D 5/12

(52) U.S. Cl. 429/120; 427/122; 427/58

(57) ABSTRACT

A battery cell pack having improved heat transfer is described. In one embodiment, the battery cell pack includes a plurality of battery cells, each battery cell having an anode foil and a cathode foil; a pair of taps, the first tap attached to the anode foil and the second tap attached to the cathode foil; wherein at least one battery cell has a high thermal conductivity coating on at least one side of the anode foil, or the cathode foil, or both; or at least one of the taps has a high thermal conductivity coating on at least one side; or both. Methods of improving the heat transfer of battery cell packs are also described.

### BACKGROUND

The invention relates generally to batteries, and more particularly to batteries which have taps and which have improved heat transfer.

Battery temperature significantly affects the performance, safety, and life of lithium ion batteries in hybrid vehicles under differing driving conditions. Uneven temperature distribution in the battery pack can lead to electrically unbalanced modules, and consequently to lower performance and shorter battery life. As a result, thermal management for lithium ion batteries is receiving increased attention from automobile manufacturers and battery suppliers. Maintaining a uniform temperature within the battery cell is difficult because of non-uniform heat generation within the battery cell. In addition, the heating and cooling systems can produce non-uniform heat transfer because of their internal thermal resistance.

The Battery Thermal Management (BTM) system plays a significant role in hybrid electric vehicle (HEV) applications by addressing lithium ion battery thermal safety in addition to improving the performance and extending the battery cycle life. The magnitude of battery heat generation rate from the modules in a pack affects the size and design of the BTM system. Battery heat generation depends on the magnitude of cell internal resistance and thermodynamic heat of the electrochemical reaction. Thus, the heat generation rate depends on the discharge/charge profile and the cell's state of charge and temperature. In order to achieve optimum performance from a battery, it is necessary to operate the battery in the desired temperature range and to reduce uneven temperature distribution. The BTM system includes controls to maintain the battery cell within the optimum temperature range and the uniformity of the temperature within individual battery cells and within the battery cell pack.

Traditionally, battery cooling designs are to remove the heat generated inside of the battery cell by external heat convection or heat conduction at the outside wall of the battery cells. This external cooling is not effective to remove heat generated inside the cell because of the thermal resistance layers on the outside of the battery cells. In addition, the external cooling will introduce a large temperature gradient across the cell thickness.

Therefore, there is a need for an improved battery cooling design.

### SUMMARY OF THE INVENTION

This need is met by the present invention. One aspect of the invention is a battery cell pack having improved heat transfer. In one embodiment, the battery cell pack includes a plurality of battery cells, each battery cell having an anode foil and a cathode foil; a pair of taps, the first tap attached to the anode foil and the second tap attached to the cathode foil; wherein at least one battery cell has a high thermal conductivity coating on at least one side of the anode foil, or the cathode foil, or both; or at least one of the taps has a high thermal conductivity coating on at least one side; or both.

Another aspect of the invention is a method of improving the heat transfer of a battery cell pack. In one embodiment, the battery pack includes a plurality of battery cells, each battery cell having an anode foil and a cathode foil; and a pair of taps, the first tap attached to the anode foil and the second tap attached to the cathode foil. The method includes coating a layer of a high thermal conductivity material on at least one of the anode foil, the cathode foil, the first tap, or the second tap.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of battery cell foils and battery cell taps.

FIG. 2 is a simulation of the thermal resistance of a battery cell without a high thermal conductivity coating.

FIG. 3 is a simulation of the thermal resistance of a battery cell with a high thermal conductivity coating.

FIG. 4 is a graph comparing the heat transfer of battery cells having different configurations of high thermal conductivity coatings.

### DETAILED DESCRIPTION OF THE INVENTION

A thermal management system with high voltage (HV) terminal cooling can provide direct cooling effects inside the cell by the current collectors. It can potentially achieve an excellent cooling performance in terms of the desired temperature range, and it can also reduce uneven temperature distribution. A high thermal conductivity coating on the foils of the battery cells, or the taps, or both is used for HV terminal cooling. It can be on one or both sides of the foils, or the taps, or both. When the coating is applied to the foils, it is only applied outside of the electrode. The high thermal conductivity coating provides improved heat transfer performance inside of the battery cell by the direct heat conduction through the collectors.

Active battery cooling is generally necessary to maintain the cell temperatures within allowable temperature limits, for example, a typical range would be about 25° C. to about 40° C. For durability and reliability, the cell temperature within the cell and across the pack should remain as uniform as possible. The temperature variation will depend on the battery cell chemistry. For example, ΔT of less than about 5° C. is suitable for many applications, although it could be higher or lower depending on the components and the application.

The present invention provides very effective internal cooling or heating of the cell to provide uniform internal cell temperatures of the battery cell. It can be used with any battery which includes taps. HV terminal cooling is provided by applying a high thermal conductivity coating on the foils, or taps, or both. In the absence of the high thermal conductivity coating, the conduction heat transfer through the taps will be very limited. The taps are welded to the foils. The foils are connected to the current collectors in the battery, which are very thin metal foils. The metal foils are connected inside the battery cells, and the metal foils provide a direct heat transfer path to the inside of the battery by heat conduction. The heat transfer rates are significantly improved by applying the high thermal conductivity coating on the taps and/or the foils.

The coating should have a thermal conductivity of greater than about 500 W/m/K, or greater than about 600 W/m/K, or greater than about 700 W/m/K, or greater than about 750 W/m/K, or greater than about 800 W/m/K, or greater than about 900 W/m/K, or greater than about 1000 W/m/K, or greater than about 1100 W/m/K, or greater than about 1200 W/m/K. Suitable coatings include, but are not limited to high thermal conductivity graphite (e.g., Kaneka GS-20 or GS-40 available from Kaneka Corp. of Osaka Japan with a thermal conductivity of about 1200 W/m/K).

The coating can optionally also have a high electrical conductivity. For example, the high thermal conductivity graphite described above has an electrical conductivity of about 10,000 S/cm. The electrical conductivity can be greater than about 5,000 S/cm, or greater than about 6,000 S/cm, or greater than about 7,000 S/cm, or greater than about 8,000 S/cm, or greater than about 9,000 S/cm, or greater than about 10,000 S/cm.

Increasing the thickness of the high thermal conductivity coatings will improve heat transfer. However, if the coating is too thick, there can be problems welding the foils to the tap. Thicknesses in the range of about 5 to about 20 microns of high thermal conductivity graphite on one or both sides of the foils, and/or the taps are suitable.

In addition, the thickness of the foils and/or the taps can be increased to further improve the heat transfer through the tap and the foils. For example, the tap is typically about 0.2 mm. Doubling the thickness to 0.4 mm will significantly increase the heat transfer. Increasing the thickness of the foils can be difficult because the foils are connected to the current collectors. The system can be optimized for cost, total weight, and manufacturability.

Considering the high localized heat generation around the current collectors, the HV terminal cooling configuration will be very effective to minimize the temperature non-uniformity within the cells and to provide an opportunity to produce the desired optimum cell temperatures with minimal power consumption. With various module configurations, the present invention can provide the basis for utilizing different battery pack cooling strategies.

An ideal thermal management system should be able to maintain the desired uniform temperature in a pack by rejecting heat in hot climates and adding heat in cold climates. A thermal management system may use air, liquid, or a combination of air and liquid for heating, cooling, and/or ventilation. The thermal management system can be passive (such that only the ambient environment is used), or active (such that a built-in source provides heating and/or cooling at extremely cold or extremely hot temperatures). Various heat sink designs can be incorporated with this invention. A thermal management system using a cold plate as the heat sink is less complicated than a system using air or liquid cooling/heating by heat convection and heat conduction.

The HV terminal cooling is very attractive because the terminal cooling can directly influence the heat transfer inside of the cell by direct heat conduction through the current collectors. One of the major problems with the HV terminal cooling is the lack of heat transfer across the battery taps. This is due to the relatively low heat conductivity of aluminum foils (about 100-200 W/m/K) combined with the small cross-sectional area for heat conduction. Although copper has a relatively higher thermal conductivity (about 300 W/m/K), the use of copper foils does not solve the problem because of the thickness of the copper foils is about half of the thickness of the aluminum foils. The high thermal conductivity of the graphite coating reduces the local heat generation near the tap due to reduced electrical resistance near the tap.

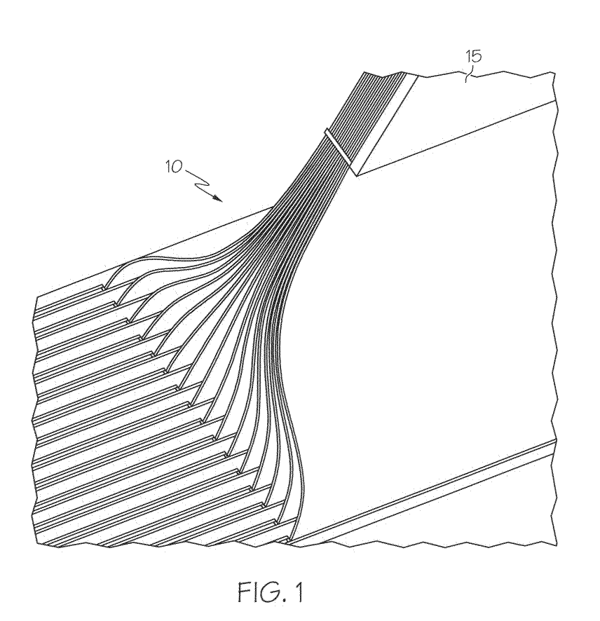

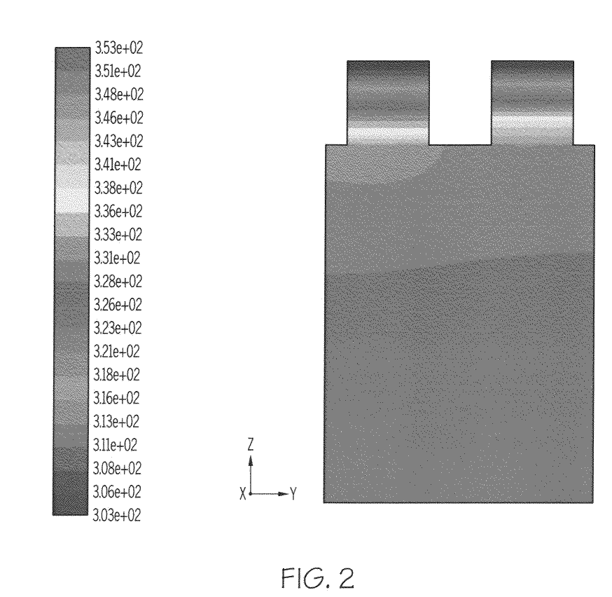

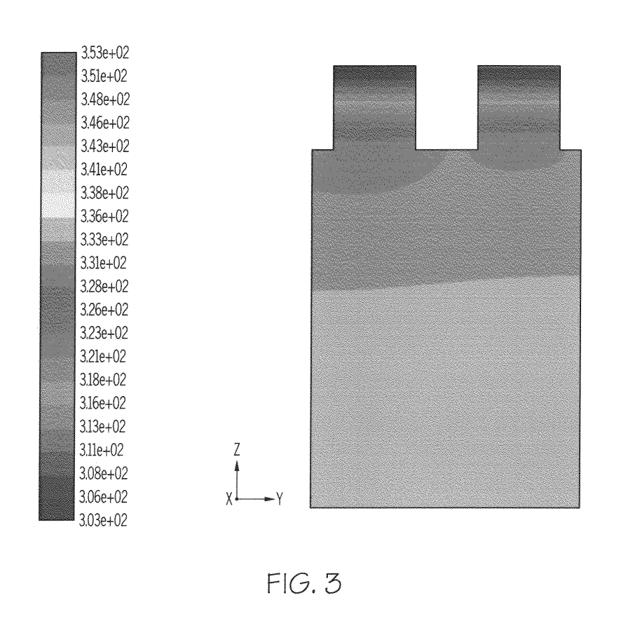

In order to enhance the heat transfer performance of the HV terminal cooling, a high thermal conductivity graphite coating was applied on the foils 10 (the tap areas outside of the current collectors as shown in FIG. 1). With a 10 micron coating on both sides of the foil 10, a significant reduction of the thermal resistance was achieved along the battery tap 15. The large heat transfer capability of the graphite coatings is demonstrated by the large cell temperature reduction due to the reduction of the thermal resistance along the tap, as shown in the simulations of FIGS. 2-3.

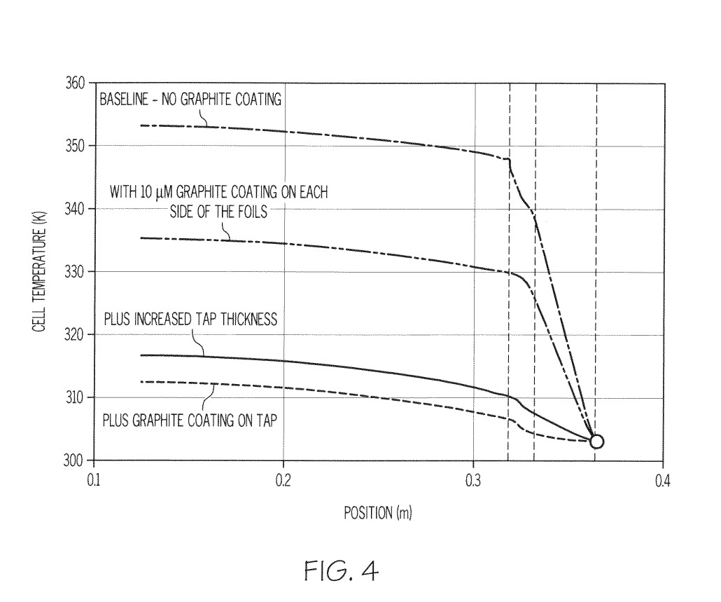

FIG. 4 is a graph illustrating the improvement of heat transfer due to the high thermal conductivity coating and increased tap thickness. Including a 10 micron high conductivity graphite coating on both sides of the foils reduced the cell temperature compared to foils without a coating. Increasing the tap thickness further reduced the cell temperature, and including a high conductivity graphite coating on the thicker tap reduced the temperature even further.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A battery cell pack having improved heat transfer comprising:
a plurality of battery cells, each battery cell having an anode foil and a cathode foil;
a pair of taps, the first tap attached to the anode foil and the second tap attached to the cathode foil;
wherein at least one battery cell has a high thermal conductivity coating on at least one side of the anode foil, or the cathode foil, or both; or at least one of the taps has a high thermal conductivity coating on at least one side; or both.

2. The battery cell pack of claim 1 wherein all of the battery cells have the high thermal conductivity coating on at least one side of the anode foil, or the cathode foil, or both; or both of the taps have the high thermal conductivity coating on at least one side; or both.

3. The battery cell pack of claim 1 wherein at least one battery cell has the high thermal conductivity coating on both sides of the anode foil, or the cathode foil, or both; or at least one of the taps has the high thermal conductivity coating on both sides; or both.

4. The battery cell pack of claim 1 wherein at least one of the battery cells has the high thermal conductivity coating on at least one side of the anode foil, or the cathode foil, or both.

5. The battery cell pack of claim 1 wherein at least one of the taps has the high thermal conductivity coating on at least one side.

6. The battery cell pack of claim 1 wherein the high thermal conductivity coating has a thermal conductivity of greater than about 500 W/m/K.

7. The battery cell pack of claim 1 wherein the high thermal conductivity coating has an electrical conductivity greater than about 5,000 S/cm.

8. The battery cell pack of claim 1 wherein the high thermal conductivity coating is a high thermal conductivity graphite coating,

9. The battery cell pack of claim 8 wherein the high thermal conductivity graphite coating has a thermal conductivity of greater than about 1000 W/m/K.

10. A method of improving the heat transfer of a battery cell pack, the battery cell pack comprising a plurality of battery cells, each battery cell having an anode foil and a cathode foil; and a pair of taps, the first tap attached to the anode foil and the second tap attached to the cathode foil, the method comprising:
coating a layer of a high thermal conductivity material on at least one of the anode foil, the cathode foil, the first tap, or the second tap.

11. The method of claim 10 wherein all of the battery cells have the high thermal conductivity coating on at least one side of the anode foil, or the cathode foil, or both; or both of the taps have the high thermal conductivity coating on at least one side; or both.

12. The method of claim 10 wherein at least one battery cell has the high thermal conductivity coating on both sides of the anode foil, or the cathode foil, or both; or at least one of the taps has the high thermal conductivity coating on both sides; or both.

13. The method of claim 10 wherein at least one of the battery cells has the high thermal conductivity coating on at least one side of the anode foil, or the cathode foil, or both.

14. The method of claim 10 wherein at least one of the taps has the high thermal conductivity coating on at least one side.

15. The method of claim 10 wherein the high thermal conductivity coating has a thermal conductivity of greater than about 500 W/m/K.

16. The method of claim 10 wherein the high thermal conductivity coating has an electrical conductivity greater than about 5,000 S/m.

17. The method of claim 10 wherein the high thermal conductivity coating is a high thermal conductivity graphite coating,

18. The method of claim 17 wherein the high thermal conductivity graphite coating has a thermal conductivity of greater than about 1000 W/m/K.

19. The method of claim 10 further comprising increasing a thickness of at least one of the anode foil, the cathode foil, the first tap, or the second tap.

20. A battery cell pack having improved heat transfer comprising:
a plurality of battery cells, each battery cell having an anode foil and a cathode foil;
a pair of taps, the first tap attached to the anode foil and the second tap attached to the cathode foil;
wherein at least one battery cell has a high thermal conductivity graphite coating on at least one side of the anode foil, or the cathode foil, or both; or at least one of the taps has a high thermal conductivity coating on at least one side; or both, the high thermal conductivity graphite coating having a thermal conductivity of greater than about 1000 W/m/K and an electrical conductivity greater than about 5,000 S/cm.
